(19) United States
(12) Patent Application Publication
(10) Pub. No.: US 2009/0325678 A1
(43) Pub. Date: Dec. 31, 2009

(54) WAGERING SYSTEM WITH EXPANDING WILD FEATURE DICTATED BY DIRECTION INDICATOR

(75) Inventor: BENJAMIN T. GOMEZ, Chicago, IL (US)

Correspondence Address: NIXON PEABODY LLP, 300 S. Riverside Plaza, 16th Floor, CHICAGO, IL, 60606, US

(73) Assignee: WMS Gaming Inc., Waukegan, IL (US)

(21) Appl. No.: 12/491,671

(22) Filed: Jun. 25, 2009

Related U.S. Application Data
(60) Provisional application No. 61/133,032, filed on Jun. 25, 2008.

(51) Int. Cl. A63F 9/24; A63F 13/00

(52) U.S. Cl. 463/20; 463/30

(57) ABSTRACT

A gaming system for conducting a wagering game includes a display and a controller. The display displays a randomly selected outcome of the wagering game including a plurality of reels with symbols forming an array. The symbols include a directional wild symbol having a direction indicator. The controller is coupled to the display and operative to (i) display the directional wild symbol on the display, (ii) provide a wild function to a symbol that is adjacent to the directional wild symbol and at a certain orientation relative to the directional wild symbol as indicated by the direction indicator, and (iii) provide an award based on the array with the adjacent symbol having the wild function.

### CLAIM OF PRIORITY AND CROSS-REFERENCE TO RELATED APPLICATION

This application claims the benefit of and priority to U.S. Provisional Patent Application No. 61/133,032, filed on Jun. 25, 2008, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines and methods for playing wagering games, and more particularly to a wagering game that has symbols that are changed to wild symbols as directed by a directional wild symbol with a direction indicator.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. The bonus game concept offers tremendous advantages in player appeal and excitement relative to other known games, and such games are attractive to both players and operators.

### SUMMARY OF THE INVENTION

According to one aspect of the present invention, a gaming system for conducting a wagering game includes a display and a controller. The display displays a randomly selected outcome of the wagering game including a plurality of reels with symbols forming an array. The symbols include a directional wild symbol having a direction indicator. The controller is coupled to the display and operative to: (i) display the directional wild symbol on the display, (ii) provide a wild function to a symbol that is adjacent to the directional wild symbol and at a certain orientation relative to the directional wild symbol as indicated by the direction indicator, the adjacent symbol being on a different one of the plurality of reels than the directional wild symbol, and (iii) provide an award based on the array with the adjacent symbol having the wild function.

According to another aspect of the invention, a method of conducting a wagering game comprises displaying, in display area, a plurality of reels having symbols that form an array. One of the symbols is a directional wild symbol with a direction indicator. The display area including a plurality of active paylines extending through symbol locations within the array. The method further includes, in response to the directional wild symbol being in the display region, using the direction indicator to identify at least one symbol in the array in a direction relative to the directional wild symbol, and altering the at least one identified symbol to be a wild symbol providing a wild symbol function. The direction indicator indicates a direction that is not vertically aligned with the plurality of reels. The method also includes awarding a payout based on an evaluation of symbol combinations along the plurality of active paylines with the at least one identified symbol having the wild symbol function.

According to another aspect of the invention, a method of conducting a wagering game comprises displaying a plurality of symbols in an array with one of the plurality of symbols being a directional wild symbol having a direction indicator. The method includes moving the direction indicator on the directional wild symbol such that the direction indicator points to multiple symbols that are not vertically aligned with the direction wild symbol during the movement, and stopping the direction indicator to identify at least one symbol in the array that is located at a certain orientation relative to the directional wild symbol. The method further includes altering the at least one identified symbol to be a wild symbol providing a wild symbol function, and awarding a payout based on an evaluation of symbol combinations within the array with the at least one identified symbol having the wild symbol function.

According to another aspect, a method of conducting a wagering game on a wagering game device, the wagering game including a game sequence initiated responsive to a player input and communication of a wagering game outcome to a player via an output from the wagering game device, the method comprising the acts of changing a state of a player input device of the wagering game device from a first state to a second state responsive to a player input, outputting to a processor a signal from the player input device relating to the change in state from the first state to the second state and, using the processor, executing machine-executable instructions relating to the wagering game responsive at least in part to the signal, wherein the machine-executable instructions cause the display, on a display associated with the wagering game device, of information relating to at least one of the wagering game sequence or the wagering game outcome, such information comprising the display of a plurality of symbols in an array with one of the plurality of symbols being a directional wild symbol having a direction indicator, the moving of the direction indicator on the directional wild symbol such that the direction indicator points to multiple symbols that are not vertically aligned with the direction wild symbol during the movement, and stopping the direction indicator to identify at least one symbol in the array that is located at a certain orientation relative to the directional wild symbol. The method further includes the act of, using the processor, executing machine-executable instructions relating to the wagering game responsive at least in part to the signal, wherein the machine-executable instructions cause the display, on a display associated with the wagering game device, an altering of the at least one identified symbol to be a wild symbol providing a wild symbol function. The method further includes the act of awarding, via a payoff mechanism, a payout based on an evaluation of symbol combinations within the array with the at least one identified symbol having the wild symbol function.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machines of FIGS. 1a and 1b;

FIG. 3 is an illustration of the primary display in which an array of symbols includes a directional wild symbol with its associated direction indicator;

FIG. 4 is an illustration of the primary display in which the array of symbols of FIG. 3 produces an enhanced winning symbol combination due to the directional wild symbol;

FIG. 5 is an illustration of the primary display in which an array of symbols includes a different directional wild symbol with its associated direction indicator;

FIG. 6 is an illustration of the primary display in which the array of symbols of FIG. 5 produces an enhanced winning symbol combination due to the directional wild symbol;

FIG. 7 is an illustration of the primary display in which an array of symbols includes a jumping wild symbol, according to a different embodiment of the present invention;

FIG. 8 is an illustration of the primary display in which the array of symbols of FIG. 7 produces an enhanced winning symbol combination due to the jumping wild symbol; and

FIG. 9 is a flow chart showing one possible algorithm that can be used for conducting the wagering game in accordance to the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention, and is not intended to limit the broad aspect of the invention to the embodiments illustrated.

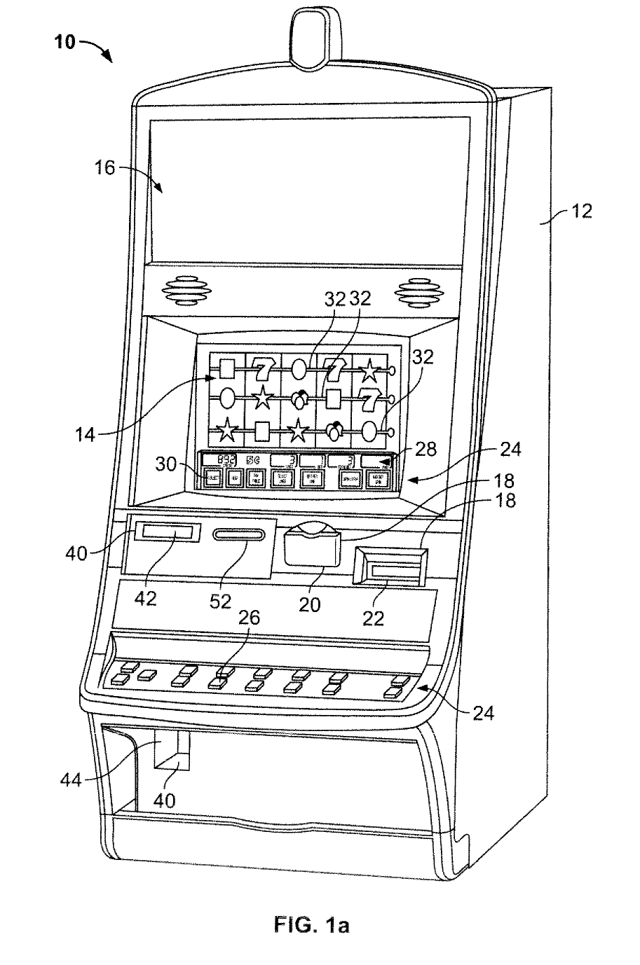

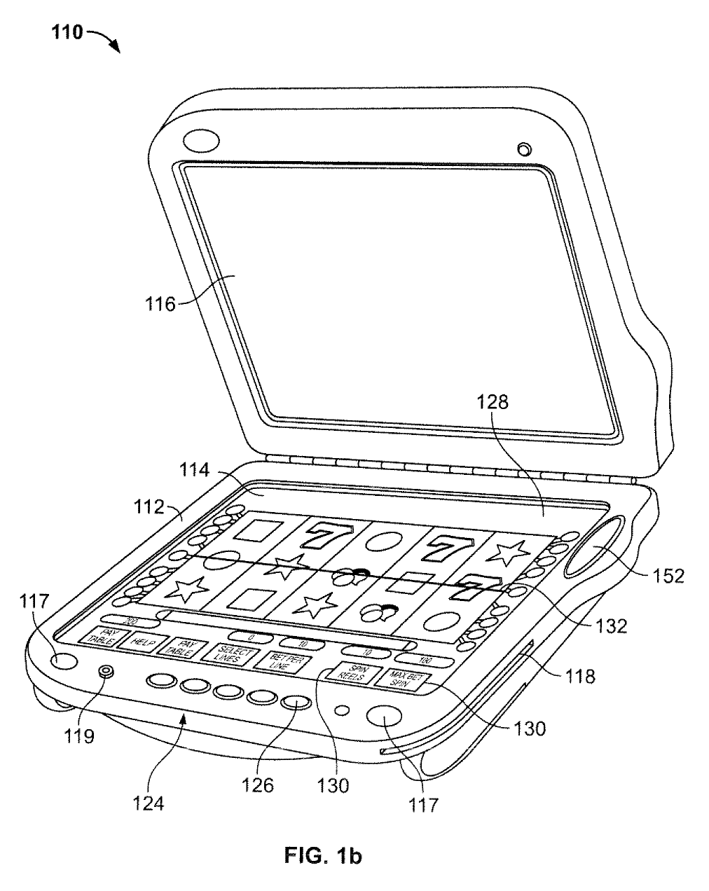

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises, in some aspects, a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. Another player input device, touch screen 28, contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or located outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, radio-frequency identification (RFID) transceiver, or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

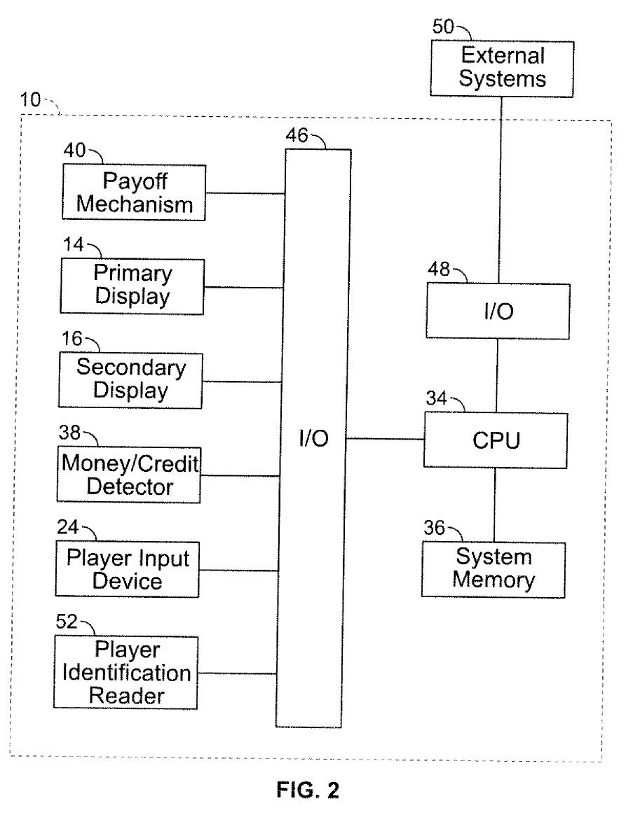

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection, e.g., using a random number generator (RNG), of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods. To provide gaming functions, the controller 34 executes one or more game programs comprising machine-executable instructions stored in local and/or remote computer-readable data storage media. The term computer-readable data storage media, or “computer-readable medium,” as used herein refers to any media/medium that participates in providing instructions to controller 34 for execution. The computer-readable medium may take many forms including, but not limited to, non-volatile media (e.g., optical disks, magnetic disks, etc.), volatile media (e.g., dynamic memory, RAM), and transmission media (e.g., coaxial cables, copper wire, fiber optics, radio frequency (RF) data communication, infrared (IR) data communication, etc). Common forms of computer-readable media include, for example, a hard disk, magnetic tape (or other magnetic medium), a CD-ROM, DVD, RAM, PROM, EPROM, FLASH-EPROM, any other memory chip or solid state digital data storage device, a carrier wave as described hereinafter, or any other medium from which a computer can read.

Various forms of computer readable media may be involved in carrying one or more sequences of one or more instructions and/or data to controller 34 for execution and/or processing. By way of example, the instructions and/or data may initially be borne on a data storage device of a remote computer. Such remote computer loads the instructions and/or data into its dynamic memory and transmits the instructions and/or data over a communication pathway (e.g., telephone line) using a communication device suitable for the communication pathway (e.g., a modem). A communication device local to the gaming machine 10 or an associated external system 50 receives the instructions and/or data (e.g., via I/O 48) and outputs the instructions and/or data to a bus (e.g., I/O 46) and to the system memory 36 and/or processor 34. The processor retrieves and executes the instructions and/or processes the data borne by the system memory. The instruction and/or data transmission process can likewise be reversed to carry instructions and/or data from the gaming machine 10 to a remote device or system via the I/O 48 and external system(s) 50. Thus, the controller 34 can send and receive instructions and/or data, including program code, through the network(s), network link, and communication interface.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10,110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

Security features are advantageously utilized where the gaming machines 10,110 communicate wirelessly with external systems 50, such as through wireless local area network (WLAN) technologies, wireless personal area networks (WPAN) technologies, wireless metropolitan area network (WMAN) technologies, wireless wide area network (WWAN) technologies, or other wireless network technologies implemented in accord with related standards or protocols (e.g., the Institute of Electrical and Electronics Engineers (IEEE) 802.11 family of WLAN standards, IEEE 802.11i, IEEE 802.11r (under development), IEEE 802.11w (under development), IEEE 802.15.1 (Bluetooth), IEEE 802.12.3, etc.). For example, a WLAN in accord with at least some aspects of the present concepts comprises a robust security network (RSN), a wireless security network that allows the creation of robust security network associations (RSNA) using one or more cryptographic techniques, which provides one system to avoid security vulnerabilities associated with IEEE 802.11 (the Wired Equivalent Privacy (WEP) protocol). Constituent components of the RSN may comprise, for example, stations (STA) (e.g., wireless endpoint devices such as laptops, wireless handheld devices, cellular phones, handheld gaming machine 110, etc.), access points (AP) (e.g., a network device or devices that allow(s) an STA to communicate wirelessly and to connect to a(nother) network, such as a communication device associated with I/O circuit(s) 48), and authentication servers (AS) (e.g., an external system 50), which provide authentication services to STAs. Information regarding security features for wireless networks may be found, for example, in the National Institute of Standards and Technology (NIST), Technology Administration U.S. Department of Commerce, Special Publication (SP) 800-97, ESTABLISHING WIRELESS ROBUST SECURITY NETWORKS: A GUIDE TO IEEE 802.11, and SP 800-48, WIRELESS NETWORK SECURITY: 802.11, BLUETOOTH AND HANDHELD DEVICES, both of which are incorporated herein by reference in their entirety.

In view of the above, a method of conducting a wagering game on a gaming system comprises acts including a game sequence in which a player makes a wager (e.g., via a player input device 24, touch screen button input, money/credit detector 38, etc.), provides an instruction to associate the wager to a wagering game (e.g., via a player input device 24 such as a “Play” button, touch screen button input, pulling a lever or “side arm”, etc.), a wagering game outcome generated by a RNG is associated with the wager, and the wagering game outcome is revealed. The instruction by the player to associate the player's wager to a wagering game comprises a physical player input (e.g., pressing a “Play” button on a button panel, pressing a touch screen button input, pulling a lever, etc.) and this physical player input is transformed into an electronic data signal indicative of an instruction relating to the wagering game.

For example, the movement of a “Play” button actuator or “Max Bet” button actuator closes (or opens) a contact, creating an electronic data signal corresponding to the player's instruction to play the wagering game. This movement of the button actuator itself involves a change in the button switch from a first state (e.g., off) to a second state (e.g., on) responsive to the player's movement of the button actuator. Likewise, other player input devices (e.g., touch screen button, etc.) change state responsive to player inputs to transform the physical player input into an electronic data signal utilizable by the gaming machine 10. To illustrate, bills and/or coins input into the money/credit detector 38 are scanned and the value of the physical currency is then transformed into an equivalent value of an electronic currency utilizable in the gaming environment, which may then be later transformed back into a corresponding value of a physical currency, a ticket, or some other value bearing media, through payoff mechanism 40, a ticket printer, or the like. In the above “Play” button example, the electronic data signal is transmitted to I/O 46 and to at least one of controller 34, system memory 36, external systems interface (I/O 48), and external system(s) 50. In at least some aspects, responsive to an electronic data signal, controller 34 causes a change of state of the data storage device comprising the system memory from a first state to a second state, wherein the second state of the data storage device comprises storage of data representing a particular electronic data signal (e.g., an instruction to play a wagering game, an increase in the number of credits input by a player, a decrementing of a number of credits associated with a player responsive to a wager, an updating of a number of credits associated with a player responsive to an award, etc.). Controller 34 is also configured to cause the display associated with the gaming machine 10, such as primary display area 14 and/or secondary display area 16, to change from a first state to a second state (and/or successive states) responsive to such electronic data signals from player input devices 24 and/or machine-executable instructions (e.g., wagering game program), wherein the second state of the display (and/or successive states) comprises a visual representation of the physical player input (e.g., a confirmation of the instruction, etc.), information relating to the physical player input (e.g., a decreased credit amount, an indicated wager amount, etc.), a game sequence as described herein (e.g., initiation of the wagering game responsive to the instruction and corresponding electronic data signal, etc.), an outcome of the game sequence, or any combination thereof.

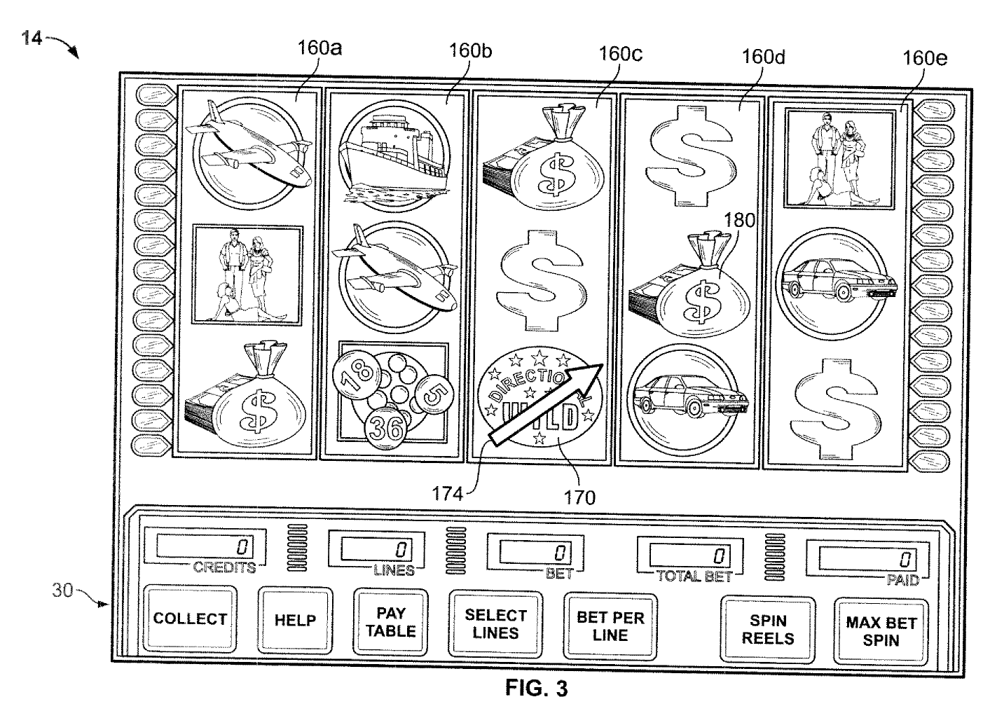

In the exemplary embodiment illustrated in FIG. 3, the primary display 14 has five reels 160. Each of the reels 160 includes a plurality of symbols that are used for indicating the randomly selected outcome of the wagering game. The plurality of reels 160 rotate and stop such that the symbols are located at symbols locations, forming an array of symbols.

One of the symbols is a directional wild symbol 170, which is shown on the middle reel 160c. The directional wild symbol 170 includes a direction indicator 174. As illustrated in FIG. 3, the direction indicator 174 is an arrow having a single arrow head. As will be described in more detail below, the direction indicator 174 serves the purpose of identifying another symbol (or symbols) in the array that will undergo an alteration, such that they become a wild symbol. The alteration may include an animated change of indicia to show the player that the symbol has changed to a wild function symbol.

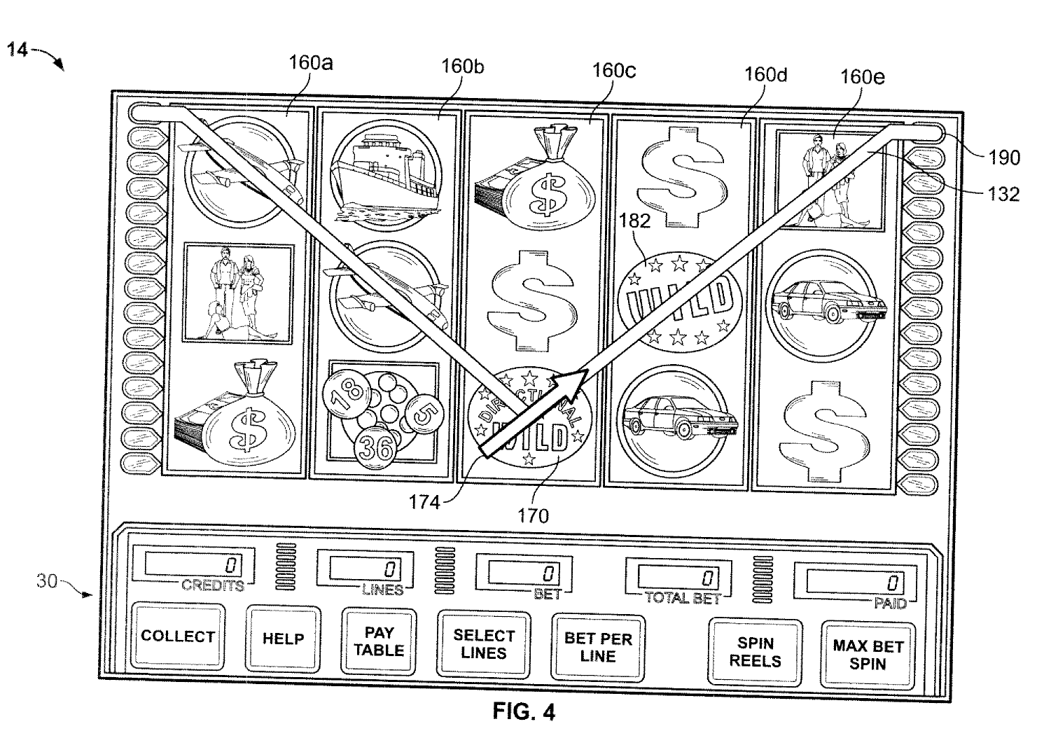

In FIG. 3, the direction indicator 174 is pointing towards the “Money Bag” symbol 180. Consequently, the “Money Bag” symbol 180 changes into a wild symbol 182, as shown in FIG. 4. Due to this alteration to create a wild symbol function, the player has achieved a winning outcome defined by four “Airplane” symbols along a V-shaped payline 32. To help illustrate the winning symbol combination, a payline indicator 190 associated with the pay line 32 may also be emphasized to show the winning combination.

In summary, the directional wild symbol 170 serves as a wild symbol, in addition to the wild symbol 182 of FIG. 4 that was created by the directional pointing effect of the direction indicator 174. And due to the direction indicator 174 causing the change of the “Money Bag” symbol 180 (FIG. 3) to the wild symbol 182 in FIG. 4, the player has achieved a better outcome defined by the four “Airplane” symbols along payline 32, rather than only three “Airplane” symbols along payline 32.

It should be noted that the direction indicator 174 can serve a function of changing more than one symbol into a wild symbol when pointing in a certain direction such that the wild function “travels” in the direction defined by the direction indicator 174. For example, in FIG. 4, the direction indicator 174 could have also caused the top symbol on reel 160e to change into a wild symbol. Similarly, if the direction indicator 174 was pointing horizontally to the right, then the two symbols oriented horizontally to the right of the directional wild symbol 170 would change into a wild symbol. Furthermore, it is possible that the directional wild symbol 170 provides no benefit to the player, which would be the case in FIG. 3 if the direction indicator 174 was pointed in a downward direction where no symbol is positioned within the display area.

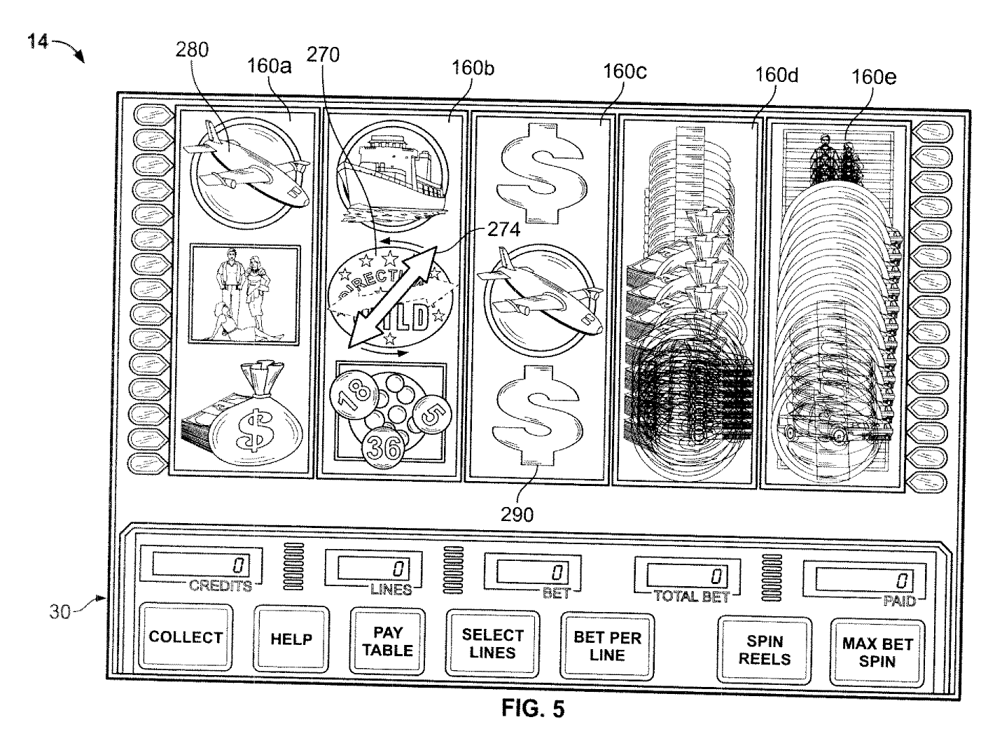

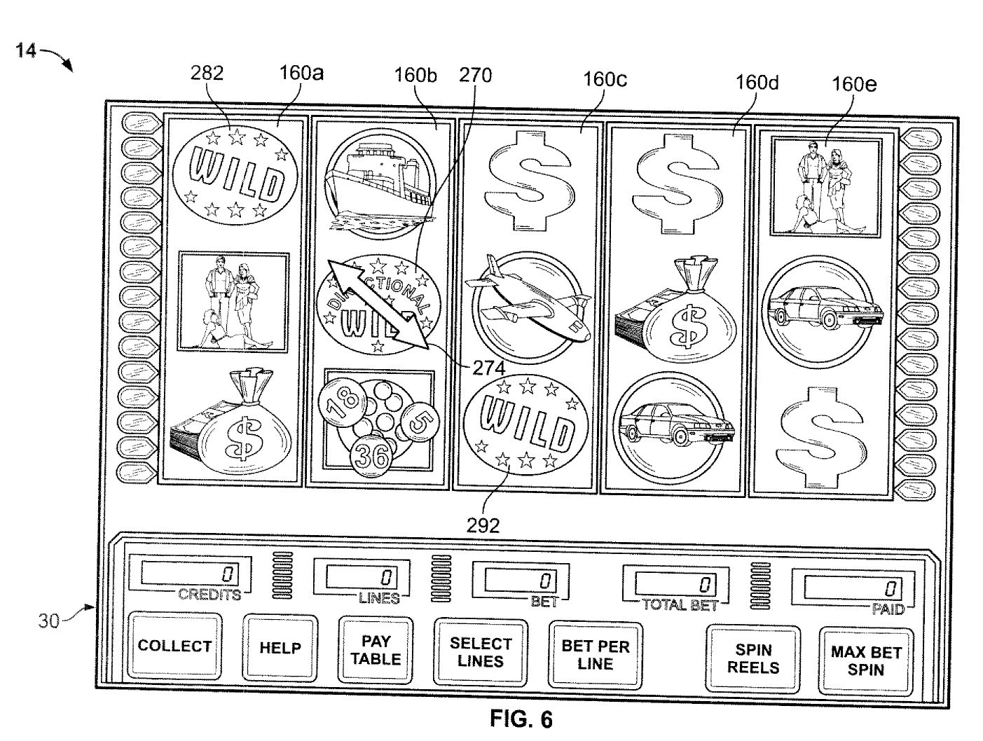

The direction indicator 174 can be static such that it remains in the same direction for a single play of the wagering game, and then changes orientation for subsequent plays. Or, it may remain in a static position for one revolution of the reel 160c through the display area, and change to a new orientation for each subsequent revolution. In a further alternative, the direction indicator 174 can have a more dynamic appearance and move (e.g. rotate) on the reel 160c as the reel 160c moves, or after the reel 160c stops, as is described in more detail below in FIGS. 5-6.

FIG. 5 shows an alternative embodiment in which the reels 160d and 160e are still spinning, while the reels 160a, 160b, and 160c have stopped. A directional wild symbol 270 is located on the second real 160b, while other symbols are also present including an “Airplane” symbol 280 on the reel 160a and a “Dollar” symbol 290 on the reel 160c. The direction indicator 274 has two arrow heads, allowing it to point in two different and opposite directions. Additionally, the direction indicator 274 is rotating such that it will have pointed to all of the adjacent symbols on the reels 160a, 160b, 160c before coming to a stop.

As shown in FIG. 6, the direction indicator 274 has stopped, causing both the “Airplane” symbol 280 on the reel 160a and the “Dollar” symbol 290 on the reel 160c to turn into two wild symbols 282 and 292, respectively. In other words, the directional wild symbol 270 has caused two adjacent symbols to transform into wild symbols. Again, this result is beneficial to the player because the two wild symbols 282, 292 provide more opportunities for achieving a winning symbol combination on the active pay lines within the array of symbols.

It should be noted that while the direction indicator 274 has been shown as moving while the reels 160d and 160e are still spinning, the direction indicator 274 can also be moving while the reel 160b is still spinning. Accordingly, the player may see the direction indicator 274 moving, while the reel 160b itself is also moving. And, as the reel 160b slowly comes to a stop, the rotational movement of the direction indicator 274 may also slowly come to a stop. In another variation, the direction indicator 274 may only begin its rotational movement after the reel 160b has stopped, or after all of the reels 160 have stopped. Any movement or change in orientation of the direction indicator 274 causes an increased sense of anticipation for the player as the player knows that the movement or change in orientation can have a drastic effect on the outcome of the wagering game, making the overall gaming experience more exciting and enjoyable for the player.

Control of the movement or change in orientation of the direction indicator 274 on the primary display 14 is caused, for example, by a processor, such as the CPU 34. The outcome that has been randomly determined by a RNG for a particular play of the wagering game may require the display of a certain winning symbol combination (or winning symbol combinations), which can be achieved by altering a symbol to have the wild symbol function, as described above.

While the illustrated embodiments employ an arrow for the direction indicator 174, 274, other types of indicia can be used for the direction indicators as well. For example, the direction indicator can be illustrated as a bottle that spins. Alternatively, the direction indicator can have multiple direction indicators, such as two clock-like hands having independent, clock-like movement, or a 4-direction cross-like indicator. In yet a further embodiment, the direction indicator 174, 274 can be limited to only change adjacent symbols on a diagonal, such that horizontal and vertical orientations will not cause a wild symbol function change. Consequently, as can be appreciated, some indicators 174, 274 may be more desirable from the player's perspective.

In yet a further embodiment, the directional wild symbol 170, 270 can have a randomly assigned direction indicator such that for some plays of the wagering game, there is one type of direction indicator (e.g., one arrow head), whereas in other plays of the wagering game there is a second type of direction indicator (e.g., two arrow heads, clock-like hands, or a cross-like indicator). Alternatively, the type of direction indicator may continuously change on the directional wild symbol 170, 270 until the last of the reels 160 has stopped such that the player has no idea of what type of indicator will be available until the reels 160 stop.

The directional wild symbol 170, 270 may only be located on certain ones of the reels. For example, the directional wild symbol 170, 270 may only be located on the 2^{nd} reel 160b and the 4^{th} reel 160d.

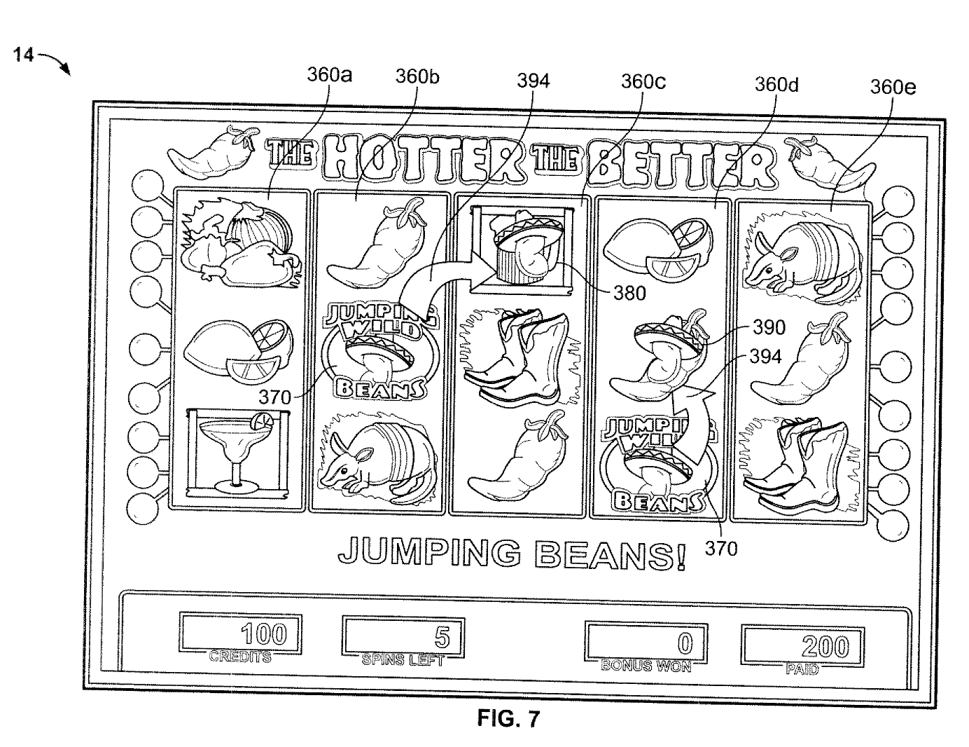

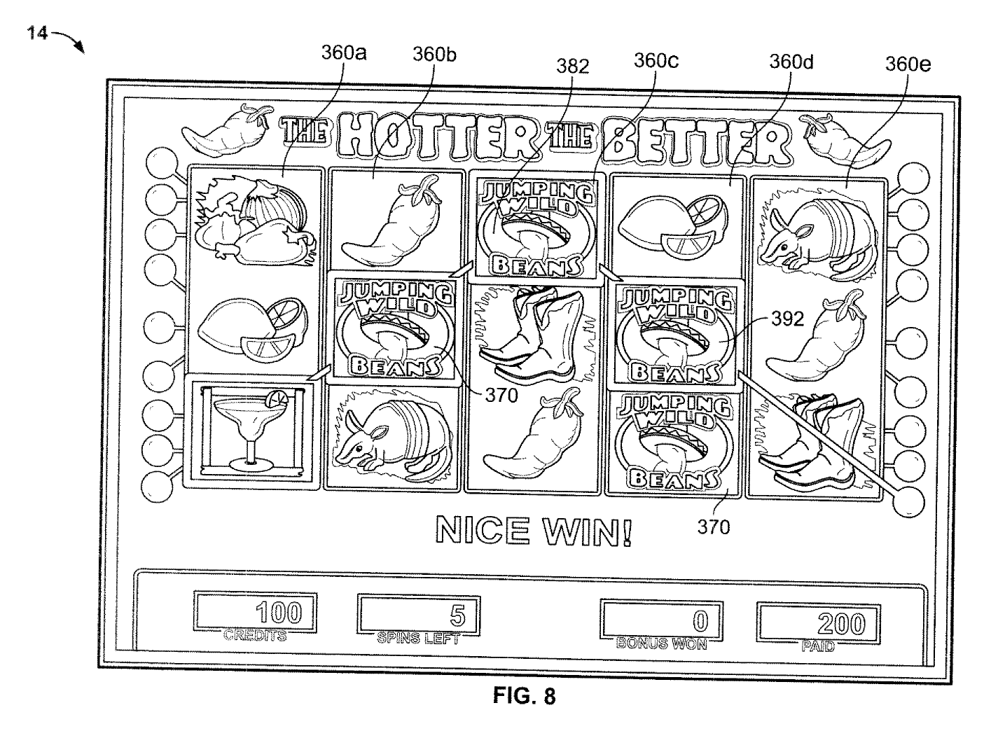

FIGS. 7 and 8 illustrate another embodiment of the invention that also causes symbols within the array of symbols to change into a wild function. In FIG. 7, the reels 360 include a plurality of symbols that form an array. One of the symbols that may appear in the array is a jumping wild symbol 370. As shown in FIG. 7, there are two jumping wild symbols 370. In this embodiment, the jumping wild symbol 370 will undergo a random directional “jump” to cause an adjacent symbol (or symbols) to be transformed into a wild symbol.

In FIG. 7, the two jumping wild symbols 370 change a first symbol 380 and a second symbol 390 into two different wild symbols 382, 392, which are shown in FIG. 8. The “jump” of the jumping wild symbol 370 may be illustrated by an arrow 390 showing the movement to the player. Or, animated video indicia may move from the jumping wild symbol 370 to the symbol that is transformed into the wild symbol.

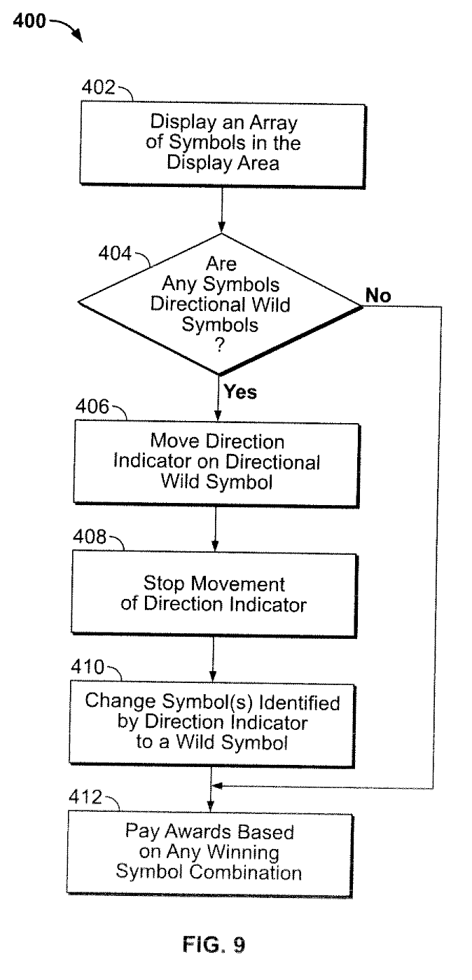

FIG. 9 illustrates one possible algorithm 400 that can be used by the controller (e.g. CPU 34) to conduct the wagering game set forth above with respect to FIGS. 1-6. At step 402, the array of symbols is displayed in a display area on the primary display 14. Next, at step 404, there is a query as to whether any symbol in the array is a directional wild symbol. If there are no directional wild symbols, then the algorithm 400 proceeds to step 412, at which the awards are paid based on the symbol combinations presented in the array.

On the other hand, if at step 404, it is determined that one of the symbols is a directional wild symbol, then the algorithm 400 proceeds to step 406 at which movement of the direction indicator for the directional wild symbol is initiated. As described above, however, the movement may already be initiated as the symbols begin populating the array. Next, at step 408, the movement of the direction indicator is stopped such that the direction indicator is pointing to at least one adjacent symbol. At step 410, the adjacent symbol identified by the direction indicator is changed to a wild symbol having a wild function. Finally, at step 412, there is a payment of awards based on any winning symbol combinations, which may include the directional wild symbol and/or the adjacent symbol that has been changed to a wild function.

Each of these embodiments and obvious variations, including combinations and subcombinations thereof, are contemplated as falling within the spirit and scope of the claimed invention, which is set forth in the following claims.

What is claimed is:

1. A method of conducting a wagering game, comprising:
displaying, in a display area, a plurality of reels having symbols that form an array, one of the symbols being a directional wild symbol with a direction indicator, the display area including a plurality of active paylines extending through symbol locations within the array;
in response to the directional wild symbol being in the display region, using the direction indicator to identify at least one symbol in the array in a direction relative to the directional wild symbol, the direction indicator indicating a direction that is not vertically aligned with the plurality of reels;
altering the at least one identified symbol to be a wild symbol providing a wild symbol function; and
with the at least one identified symbol having the wild symbol function, awarding a payout based on an evaluation of symbol combinations along the plurality of active paylines.

2. The method of claim 1, wherein the directional wild symbol is also a wild symbol having a wild symbol function.

3. The method of claim 1, wherein using the direction indicator includes moving the direction indicator to point to other symbols and stopping the direction indicator to point to the at least one symbol in the array.

4. The method of claim 3, wherein the moving of the direction indicator occurs while the reel bearing the directional wild symbol is moving.

5. The method of claim 3, wherein the moving and stopping of the direction indicator at least partially occurs after the reel bearing the directional wild symbol has stopped.

6. The method of claim 3, wherein the direction indicator spins on top of the directional wild symbol.

7. The method of claim 1, wherein the direction indicator identifies two symbols causing the two symbols to have the wild symbol function.

8. The method of claim 6, wherein the direction indicator identifies the two symbols by pointing in two distinct directions while stopped.

9. The method of claim 1, wherein the altering includes changing the indicia associated with the at least one symbol so as to indicate the wild symbol function to the player.

10. The method of claim 1, wherein the at least one symbol indicated by the direction indicator can only be at a diagonal relative to the directional wild symbol.

11. The method of claim 1, wherein the directional wild symbol does not move from a respective one of the plurality of reels during the identifying the at least one symbol and during the altering the at least one identified symbol.

12. The method of claim 1, wherein the plurality of reels includes five horizontally-spaced reels, and wherein the directional wild symbol must be located on one of the three central reels of the five horizontally-spaced reels.

13. A computer-readable storage medium encoded with instructions for directing a gaming machine to perform the method of claim 1.

14. A gaming system for playing a wagering game, comprising:
a display displaying a randomly selected outcome of the wagering game including a plurality of reels with symbols forming an array, the symbols including at least one directional wild symbol having a direction indicator; and
a controller coupled to the display and operative to (i) display the at least one directional wild symbol on the display, (ii) provide a wild function to a symbol that is adjacent to the at least one directional wild symbol and at a certain orientation relative to the at least one directional wild symbol as indicated by the direction indicator, the adjacent symbol being on a different one of the plurality of reels than the directional wild symbol, and (iii) provide an award based on the array with the adjacent symbol having the wild function.

15. The gaming system of claim 14, wherein the display further includes a plurality of active paylines, the controller being operative to evaluate symbol combinations along the plurality of active paylines, at least one of the symbol combinations having the adjacent symbol with the wild function.

16. The gaming system of claim 15, wherein the at least one directional wild symbol also has a wild function.

17. The gaming system of claim 16, wherein the at least one of the symbol combinations further includes the at least one directional wild symbol.

18. The gaming system of claim 14, wherein the controller is further operative to display the movement of the direction indicator.

19. The gaming system of claim 18, wherein the movement is a rotational movement, and wherein after the rotational movement, the controller is further operative to stop the movement of the direction indicator such that the direction indicator is pointing toward the adjacent symbol.

20. The gaming system of claim 14, wherein the controller is further operative to change the indicia of the adjacent symbol to indicate the wild function.

21. A method of conducting a wagering game, comprising:
displaying a plurality of symbols in an array, one of the plurality of symbols being a directional wild symbol having a direction indicator;
moving the direction indicator on the directional wild symbol such that the direction indicator points to multiple symbols that are not vertically aligned with the direction wild symbol during the movement;
stopping the direction indicator to identify at least one symbol in the array that is located at a certain orientation relative to the directional wild symbol;
altering the at least one identified symbol to be a wild symbol having a wild symbol function; and
awarding a payout based on an evaluation of symbol combinations within the array with the at least one identified symbol having the wild symbol function.

22. The method of claim 21, further including displaying a plurality of active paylines within the array, and evaluating symbol combinations along the plurality of active paylines, at least one of the symbol combinations having the at least one identified symbol with the wild function.

23. The method of claim 21, wherein the plurality of symbols are on a plurality of reels, and the displaying includes spinning the reels and stopping the reels.

24. The method of claim 23, wherein moving the direction indicator occurs while the reels are spinning.
